(19) United States
(12) Patent Application Publication
(10) Pub. No.: US 2021/0350992 A1
(43) Pub. Date: Nov. 11, 2021

(54) WINDING DEVICE FOR WINDING COIL WIRE FOR A RELAY

(71) Applicant: Phoenix Contact GmbH & Co. KG, Blomberg (DE)

(72) Inventors: Ralf Hoffmann, Berlin (DE); Peter WARTMANN, Stahnsdor (DE); Mario ABENDROTH, Brieselang (DE)

(21) Appl. No.: 17/283,691

(22) PCT Filed: Sep. 24, 2019
(86) PCT No.: PCT/EP2019/075688

§ 371 Date: Apr. 8, 2021

(30) Foreign Application Priority Data
Oct. 26, 2018 (BE) BE2018/5740

(51) Int. Cl. H01H 50/44; H01H 50/16; H01H 49/00; H01F 41/082; H01F 41/09

(52) U.S. Cl. CPC H01H 50/443; H01H 50/16; H01F 41/09; H01F 41/082; H01H 49/00

(57) ABSTRACT

The present disclosure relates to a winding device for a coil yoke of a relay. The coil yoke may include first and second yoke limbs each with first and second coil formers that extend in the direction of first and second longitudinal axes and are arranged parallel to one another. The winding device comprises a rotatable coil receptacle which can be rotated around an axis of rotation which is oriented parallel to the first and second longitudinal axes, to hold the coil yoke. The coil receptacle may support the coil yoke displaceably transversely to the axis of rotation to position the coil formers with the first and second longitudinal axes on the axis of rotation for winding coil wire onto said first and second coil formers. The winding device may also include a winding nozzle configured to dispense the coil wire parallel to the axis of rotation.

### CROSS-REFERENCE TO RELATED APPLICATIONS

The present application is the national phase entry under 35 U.S.C. 371 of International Patent Application No. PCT/EP2019/075688 by Hoffmann et al., entitled “WINDING DEVICE FOR WINDING COIL WIRE FOR A RELAY,” filed Sep. 24, 2019, and claims the benefit of Belgian Patent Application No. BE2018/5740 by Hoffmann et al., entitled “WICKELVORRICHTUNG ZUM WICKELN VON SPULENDRAHT FÜR EIN RELAIS,” filed Oct. 26, 2018, each of which is assigned to the assignee hereof and is incorporated by reference in its entirety.

### FIELD OF THE DISCLOSURE

The present disclosure relates to a device for winding coils, in particular a device for winding coils of a relay.

### BACKGROUND

To wind coil wire on a coil former, the coil former is usually rotated along its longitudinal axis and the coil wire to be wound on the coil former is dispensed to the coil former in a direction perpendicular to the axis of rotation of the coil former. By moving the coil wire guide along the longitudinal axis, a spiral winding on the coil former can thus be achieved. Such a method is useless, however, if it is a matter of winding two separate windings around two coil formers which are arranged parallel to one another and are arranged, for example, on a U-shaped coil yoke. In order to wind two separate windings on two coil formers arranged in this way, it is therefore necessary to first wind the two coil formers individually and only to arrange the coil formers already provided with windings on the yoke limbs of the coil yoke. However, such a method is not efficient.

### SUMMARY

It is therefore the object of the present disclosure to provide a more efficient winding device for winding coil wire onto coil formers of a relay and an improved method for winding coil wire onto coil formers of a relay.

This object is achieved by the subject matter of the independent claims. Advantageous examples of the disclosure are the subject matter of the dependent claims, the description, and the accompanying figures.

According to a first aspect, the disclosure relates to a winding device for winding coil wire onto a first coil former and a second coil former of a coil yoke of a relay, the coil yoke having a first yoke limb with a first coil former and a second yoke limb with a second coil former, wherein the first coil former extends in the direction of a first longitudinal axis, wherein the second coil former extends in the direction of a second longitudinal axis, and wherein the first coil former and the second coil former are arranged next to each other and are oriented parallel to one another, with a rotatable coil receptacle for holding the coil yoke, wherein the coil receptacle is rotatable around an axis of rotation, wherein the axis of rotation is oriented parallel to the first longitudinal axis and the second longitudinal axis, and wherein the coil receptacle is configured to support the coil yoke displaceably transversely to the axis of rotation in order to position the first coil former for winding coil wire onto the first coil former, such that the first longitudinal axis coincides with the axis of rotation, and to position the second coil former for winding coil wire onto the second coil former in such a way that the second longitudinal axis coincides with the axis of rotation, and a winding nozzle which is configured to dispense the coil wire parallel to the axis of rotation.

This realizes the technical advantage of realizing a winding device with the smallest possible installation space and an increased winding speed, which makes it possible to produce two separate coil formers for two coil formers arranged next to one another.

By positioning one of the first and second coil formers on the axis of rotation, so that its longitudinal axis coincides with the axis of rotation, it is achieved that with a rotation of the coil receptacle around the axis of rotation, this particular coil former is rotated around its longitudinal axis. The respective other coil former rotates around the axis of rotation and around the longitudinal axis of the coil former positioned on the axis of rotation.

With the parallel alignment of the winding nozzle to the axis of rotation and to the longitudinal axis of the coil former positioned on the axis of rotation and with the positioning of the winding nozzle directly next to the coil former positioned on the axis of rotation, it is achieved that the coil wire of the winding nozzle is wound exclusively onto the coil former due to the rotation of the coil receptacle whose longitudinal axis coincides with the axis of rotation.

By moving the coil yoke within the coil receptacle transversely to the axis of rotation, the previously unwound coil former can be positioned in such a way that its longitudinal axis coincides with the axis of rotation. With the rotation of the coil receptacle around the axis of rotation and around the longitudinal axis of the coil former, which is now positioned on the axis of rotation, only a winding-around of this coil former can be realized. Thus, in one winding process, two separate and consecutive windings of the first and second coil former are possible without the coil yoke being removed from the winding device.

Due to the rotation of the coil receptacle and thus the rotation of the coil former to be wound around relative to a winding nozzle arranged parallel to the axis of rotation, it is possible to avoid using a winding nozzle that can rotate around the respective coil former for winding the individual coil former. As a result, the installation space of the winding device can be reduced since there is no need for an expensive rotatable and pivotable support of the winding nozzle and a corresponding drive for the winding nozzle can be omitted.

In addition, the rotatable support of the coil receptacle can be configured in a technically simpler manner, since the coil receptacle only rotates by itself around the axis of rotation extending through the coil receptacle, in contrast to a rotation of the winding nozzle around an axis of rotation arranged outside the winding nozzle. This enables higher rotation speeds and consequently shorter winding times, as well as a higher winding precision and, associated with this, a higher quality of the windings produced.

In some examples, the coil receptacle is configured to wind the coil wire of the winding nozzle onto that coil former, whose longitudinal axis coincides with the axis of rotation, by the rotation around the axis of rotation. This achieves the technical advantage that the winding nozzle can be held in place in order to wind coil wire around the coil former. This is advantageous because it allows the winding device to be configured with less installation space. Furthermore, the winding nozzle, which is held stationary during the winding process, enables a more precise and less error-prone winding than a winding nozzle rotating around the coil former.

In some examples, the coil receptacle is configured to rotate in a first direction of rotation around the axis of rotation in order to produce a first winding of the first coil former with a first winding direction, and to rotate in a second direction of rotation around the axis of rotation to produce a second winding of the second coil former with a second winding direction which is opposite to the first winding direction. This has the advantage that the winding device can achieve two windings, each with a respective opposite winding directions, in one winding process on a coil yoke with two coil cores.

In some examples, the winding nozzle can be moved parallel to the axis of rotation and back and forth along the coil former, whose longitudinal coincides with the axis of rotation, in order to achieve a uniform winding of the coil former with coil wire. This has the technical advantage of a spiral winding that extends over the entire length of the coil former. Furthermore, the translational movement of the non-rotating winding nozzle achieves a solution to achieve a spiral winding that is technically as simple as possible to implement. By repeatedly moving the winding nozzle back and forth, a spiral winding with several layers of coil wire can also be achieved.

In some examples, the coil receptacle comprises an upper receiving part and a lower receiving part, and wherein the coil yoke is held between the upper receiving part and the lower receiving part. This has the technical advantage that the coil yoke is held securely in the coil receptacle.

In some examples, the upper receiving part and the lower receiving part are releasably connected to one another via connecting means. This has the technical advantage that the coil yoke is held securely in the coil receptacle via a clamping connection between the upper and lower receiving parts. Furthermore, it is achieved that the coil yoke can easily be released again by releasing the connection of the upper and lower receiving parts from the position by the upper and lower receiving parts.

In some examples, the upper receiving part and/or the lower receiving part has passages arranged next to one another, which can be penetrated by the first yoke limb and the second yoke limb, the first coil former and the second coil former being arranged outside the passages. This achieves the technical advantage that the coil yoke is held securely between the upper and lower receiving parts. Furthermore, the penetration of the passages through the yoke limbs prevents the coil yoke from slipping transversely to the axis of rotation. Furthermore, by arranging the coil formers outside of the passages, it is achieved that the coil formers can be completely wound-around with coil wire.

In some examples, the passages arranged next to one another define a first positioning of the coil yoke and a second positioning of the coil yoke in the coil receptacle, wherein in the first positioning the first longitudinal axis of the first coil former coincides with the axis of rotation, and wherein in the second positioning the second longitudinal axis of the second coil former coincides with the axis of rotation. This achieves the technical advantage that it is easier to position the first and second coil formers in such a way that the first and second longitudinal axes coincide with the axis of rotation. This ensures that the coil yoke is held in the coil receptacle in such a way that at any time one of the first and second coil formers is exactly oriented to the axis of rotation of the coil receptacle for winding coil wire around.

In some examples, the coil receptacle has a plurality of passages, which penetrate the coil receptacle perpendicular to the axis of rotation and are provided to expose electrical connections, in particular connecting pins, of the coil yoke for the electrical connection of coil wire. This has the technical advantage that in order to wind the connection pins of the coil yoke with coil wire through the winding nozzle, the coil yoke does not have to be removed from the coil receptacle and can instead be carried out during the winding process.

In some examples, the coil receptacle has a plurality of support pins which are configured to fix the coil wire to the coil receptacle during the winding process. A simple fixation of the coil wire to the coil receptacle is achieved by the support pins. As a result, the coil wire is held on the coil receptacle during the winding process and after completion, and the tension of the coil wire of the winding nozzle is maintained.

In some examples, the elongated winding nozzle can be pivoted vertically from the position parallel to the axis of rotation in order to enable the connection pins of the coil yoke to be wound. This has the technical advantage that no additional device is required for winding around the connection pins of the coil yoke, but this can be done by the winding nozzle. Furthermore, the pivotably supported winding nozzle realizes a winding device with the smallest possible installation space.

In some examples, the winding nozzle can be pivoted transversely to the axis of rotation in the vertical position in order to reach different connection pins of the coil yoke and/or different support pins of the coil receptacle for winding with coil wire. This in turn achieves the technical advantage that no additional device is required for winding around the connection pins, but by pivoting the winding nozzle perpendicular to the axis of rotation, the winding nozzle, all connection pins of the coil yoke and support pins of the coil receptacle can be reached. Furthermore, the pivotably supported winding nozzle realizes a winding device with the smallest possible installation space.

In some examples, the winding nozzle is translationally movable in the vertical position along a first direction, which is oriented parallel to the axis of rotation, along a second direction, which is oriented perpendicular to the first direction, and along a third direction, which is oriented perpendicular to the first direction and the second direction. This ensures that all connection pins of the coil yoke and all support pins of the coil receptacle can be reached through the winding nozzle.

In some examples, the winding nozzle can be rotated in the vertical position around a second axis of rotation oriented at an right angle to the axis of rotation of the coil receptacle in order to achieve the winding of the connecting pins of the coil yoke and/or the support pins of the coil receptacle with coil wire. This in turn has the technical advantage that no additional device is required for winding the connection pins and the support pins, but rather, due to the rotational movement of the winding nozzle perpendicular to the axis of rotation, the winding nozzle can wind around all connection pins and support pins of the winding receptacle. Furthermore, the rotatably supported winding nozzle realizes a winding device with the smallest possible installation space.

In some examples, the winding nozzle is configured to separate coil wire between a wound connection pin of the coil yoke and a wound support pin in order to end the winding process. This has the technical advantage that, at the end of the winding process, the coil wire is automatically separated between the connection pins of the coil yoke and the corresponding support pins, so that manual cutting of the coil wire and thus manual detachment of the coil yoke with the completed first and second windings from the coil wire of the winding nozzle is avoidable. Furthermore, the coil wire remains on at least one support pin of the coil receptacle, so that tension in the winding wire of the winding nozzle can be maintained.

In some examples, the first and the second coil formers are shaped sleeve-like from a dielectric material. This achieves the technical advantage of a coil winding that is technically as efficient as possible.

According to a second aspect, the disclosure relates to a method for winding coil wire on a first coil former and a second coil former of a coil yoke of a relay, the coil yoke having a first yoke limb with a first coil former and a second yoke limb with a second coil former, wherein the first coil former extends in the direction of a first longitudinal axis, wherein the second coil former extends in the direction of a second longitudinal axis, wherein the first coil former and the second coil former are arranged next to each other and are oriented parallel to one another, with the method steps of arranging the coil yoke in a rotatable coil receptacle, which is rotatable around an axis of rotation, the axis of rotation being oriented parallel to the first longitudinal axis and that of the second longitudinal axis, displacement of the coil yoke in the coil receptacle transversely to the axis of rotation and positioning of one of the first and second coil former, so that its longitudinal axis coincides with the axis of rotation, dispensing of coil wire parallel to the longitudinal axis of a coil former to the coil former, the longitudinal axis of which coincides with the axis of rotation, through a winding nozzle, rotating the coil receptacle around the axis of rotation, in order to wind the coil wire of the winding nozzle onto the coil former, whose longitudinal axis coincides with the axis of rotation.

This ensures that during a winding process two coil formers arranged parallel and next to each other are wound around consecutively and separately with coil wire and thus two windings can be achieved, a first winding being arranged on the first coil former and a second winding being arranged on the second coil former.

The method can be carried out by the device according to the first aspect. Further features of the method result directly from the examples and/or the functionality of the device.

### BRIEF DESCRIPTION OF THE DRAWINGS

Further examples are explained with reference to the accompanying figures.

FIG. 1A is a schematic perspective view of the winding device according to an example described herein;

FIG. 1B is a schematic side view of the winding device in FIG. 1A;

FIG. 1C is a schematic plan view of the winding device in FIG. 1A;

FIG. 1D is a schematic enlarged front view of the winding device in FIG. 1A;

FIG. 2A shows a schematic perspective view of the winding device according to an example described herein;

FIG. 2B is a schematic side view of the winding device in FIG. 2A;

FIG. 2C is a schematic plan view of the winding device in FIG. 2A;

FIG. 2D is a schematic enlarged front view of the winding device in FIG. 2A;

FIG. 3A shows a schematic perspective view of the winding device according to an example described herein;

FIG. 3B is a schematic plan view of the winding device in FIG. 3A;

FIG. 3C is a schematic side view of the winding device in FIG. 3A;

FIG. 3D is a schematic plan view of the winding device in FIG. 3A;

FIG. 3E is a schematic enlarged front view of the winding device in FIG. 3A;

FIG. 4A shows a schematic perspective view of the winding device according to an example described herein;

FIG. 4B is a schematic plan view of the winding device in FIG. 4A;

FIG. 4C is a schematic side view of the winding device in FIG. 4A;

FIG. 4D is a further schematic plan view of the winding device in FIG. 4A;

FIG. 4E is a schematic enlarged front view of the winding device in FIG. 4A;

FIG. 5A is a schematic perspective view of the winding device according to an example described herein;

FIG. 5B is a schematic plan view of the winding device in FIG. 5A;

FIG. 5C is a schematic side view of the winding device in FIG. 5A;

FIG. 5D shows a further schematic plan view of the winding device in FIG. 5A;

FIG. 5E is a schematic enlarged front view of the winding device in FIG. 5A;

FIG. 6A shows a schematic perspective view of the winding device according to an example described herein;

FIG. 6B is a schematic plan view of the winding device in FIG. 6A;

FIG. 6C is a schematic side view of the winding device in FIG. 6A;

FIG. 6D shows a further schematic plan view of the winding device in FIG. 6A;

FIG. 6E is a schematic enlarged front view of the winding device in FIG. 6A;

FIG. 7A is a schematic enlarged front view of the winding device according to an example described herein;

FIG. 7B is a schematic plan view of the winding device in FIG. 7A;

FIG. 7C is a schematic perspective view of the winding device in FIG. 7A;

FIG. 8A is a schematic enlarged front view of the winding device according to an example described herein;

FIG. 8B is a schematic plan view of the winding device in FIG. 8A;

FIG. 8C is a schematic perspective view of the winding device in FIG. 8A;

FIG. 9A is a schematic enlarged front view of the winding device according to an example described herein;

FIG. 9B is a schematic plan view of the winding device in FIG. 9A;

FIG. 9C is a schematic perspective view of the winding device in FIG. 9A; and

FIG. 10 are schematic views of different perspectives of a coil yoke of a relay according to an example described herein.

### DETAILED DESCRIPTION

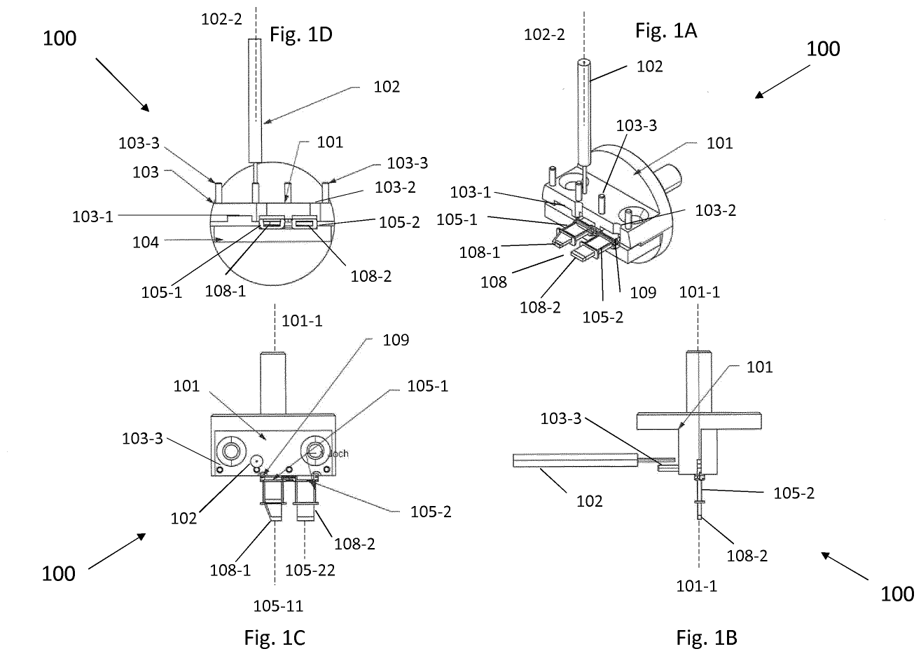

FIG. 1A shows a schematic perspective view of the winding device 100 according to an example described herein, wherein the coil yoke 108 is positioned in the first positioning in the coil receptacle 101, and wherein the winding nozzle 102 is positioned in the vertical position.

According to FIG. 1A a winding device 100 comprises for winding coil wire onto a first coil former 105-1 and a second coil former 105-2 of a coil yoke 108 of a relay, the coil yoke 108 having a first yoke limb 108-1 with a first coil former 105-1 and having a second yoke limb 108-2 with a second coil former 105-2, the first coil former 105-1 extending in the direction of a first longitudinal axis 105-11, the second coil former 105-2 extending in the direction of a second longitudinal axis 105-22, and wherein the first coil former 105-1 and the second coil former 105-2 are arranged next to each other and are oriented parallel to one another, a rotatable coil receptacle 101 for holding the coil yoke 108, the coil receptacle 101 being rotatable around an axis of rotation 101-1, wherein the axis of rotation 101-1 is oriented parallel to the first longitudinal axis 105-11 and to the second longitudinal axis 105-22, and wherein the coil receptacle 101 is formed to support the coil yoke 108 displaceably transversely to the axis of rotation 101-1 in order to position the first coil former 105-1 for winding coil wire onto the first coil former 105-1 such that the first longitudinal axis 105-11 coincides with the axis of rotation 101-1, and in order to wind coil wire onto the second coil form 105-2 to position the second coil form 105-2 such that the second longitudinal axis 105-22 coincides with the axis of rotation 101-1, and a winding nozzle 102, which is configured to dispense the coil wire parallel to the axis of rotation 101-1.

In some examples, the coil receptacle 101 is configured with an upper receiving part 103 and a lower receiving part 104, the upper and lower receiving parts 103, 104 each being configured to hold the coil yoke 108 in the coil receptacle 101.

As shown in FIG. 1A, in some examples, the upper receiving part 103 of the coil receptacle 101 comprises a plurality of passages 103-1 which are configured to be penetrated by the first and second yoke limbs 108-1, 108-2. The plurality of passages 103-1 of the upper receiving part 103 makes it possible to arrange the coil yoke 108 in a first position and a second position on the coil receptacle 101. In FIG. 1A, as also in FIGS. 1B to 1D, the coil yoke 108 is shown arranged in the first position at the coil receptacle 101.

In some examples, in the first positioning of the coil yoke 108 at the coil receptacle 101, the first coil former 105-1 is positioned on the axis of rotation 101-1, so that the first longitudinal axis 105-11 coincides with the axis of rotation 101-1 of the coil receptacle 101.

As shown in FIG. 1A, in some examples, the passages 103-1 are configured in such a way that they can be penetrated by the first and second yoke limbs 108-1, 108-2 of the coil yoke 108, while the first and second coil formers 105-1, 105-2 are arranged outside the coil receptacle 101.

According to FIG. 1A, in some examples, the coil receptacle 101 has a plurality of openings 103-2. The openings 103-2 penetrate the coil receptacle 101 in the vertical direction and are configured such that the winding nozzle 102 has access to the connection pins 109 of the coil yoke 108 and the connection pins 109 can be wound around with coil wire.

As shown in FIG. 1A, the support pins 103-3 extend in a direction perpendicular to the axis of rotation 101-1 of the coil receptacle 101. In some examples, the winding nozzle 102 is configured to execute a rotational movement around a second axis of rotation 102-2 in order to wind around the support pins 103-3 of the coil receptacle 101 and the connection pins 109 of the coil yoke 108. According to FIG. 1A, the second axis of rotation 102-2 is oriented along the vertical position.

In some examples, the winding nozzle 102 for winding around the support pins 103-3 of the coil receptacle 101 and the connecting pins 109 of the coil yoke 108 can be pivoted into the vertical position and can be pivoted along a direction transverse to the axis of rotation 101-1 of the coil receptacle 101.

In some examples, the winding nozzle 102 can also be moved translationally along the axis of rotation 101-1 and along two directions perpendicular to the axis of rotation 101-1. According to FIG. 1A, these three perpendicular directions correspond to the three spatial directions, so that the winding nozzle 102 can be displaced longitudinally to the coil receptacle 101, transversely to the coil receptacle 101 and vertically to the coil receptacle 101.

FIG. 1B shows a schematic side view of the winding device 100 in FIG. 1A.

FIG. 1C shows a schematic top view of the winding device 100 in FIG. 1A.

FIG. 1D shows a schematic enlarged front view of the winding device 100 in FIG. 1A.

To start the winding process, the coil yoke 108 is positioned in the first position in the coil receptacle 101, so that the first longitudinal axis 105-11 of the first coil former 105-1 coincides with the axis of rotation 101-1. Furthermore, the winding nozzle 102 is pivoted into the vertical position and a support pin 103-3 of the coil receptacle 101 is wound with coil wire through the winding nozzle 102.

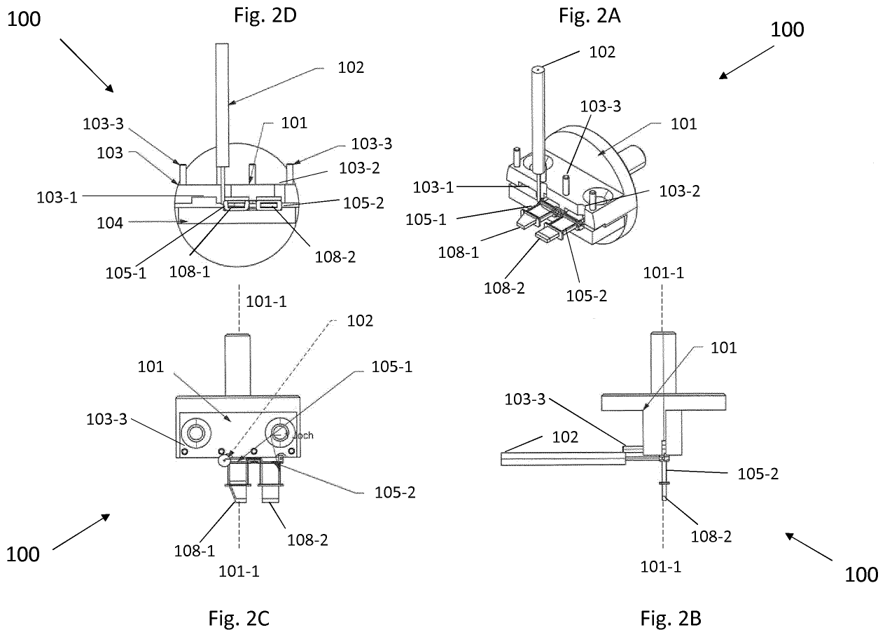

FIG. 2A shows a schematic perspective view of the winding device 100 according to an example described herein, wherein the coil yoke 108 is positioned in the first positioning in the coil receptacle 101, and wherein the winding nozzle 102 is positioned in the vertical position.

Compared to FIG. 1A, in FIG. 2A the winding nozzle 102 is lowered in the vertical direction relative to the coil receptacle 101 in the direction towards the coil yoke 108. In some examples, the winding nozzle 102 is translationally displaceable in the vertical position along the vertical direction. Furthermore, in some examples, the winding nozzle 102 is configured to wind coil wire around a connecting pin 109 by a rotational movement around the second axis of rotation 102-2, in order to fix the coil wire on the coil yoke 108.

Furthermore, according to FIG. 2A, in the first positioning, the coil yoke 108 is positioned on the coil receptacle 101 in such a way that the passages 103-2 expose a connection pin 109 of the coil yoke 108 and make it accessible to the winding nozzle 102.

FIG. 2B shows a schematic side view of the winding device 100 in FIG. 2A.

FIG. 2C shows a schematic top view of the winding device 100 in FIG. 2A.

FIG. 2D shows a schematic enlarged front view of the winding device 100 in FIG. 2A.

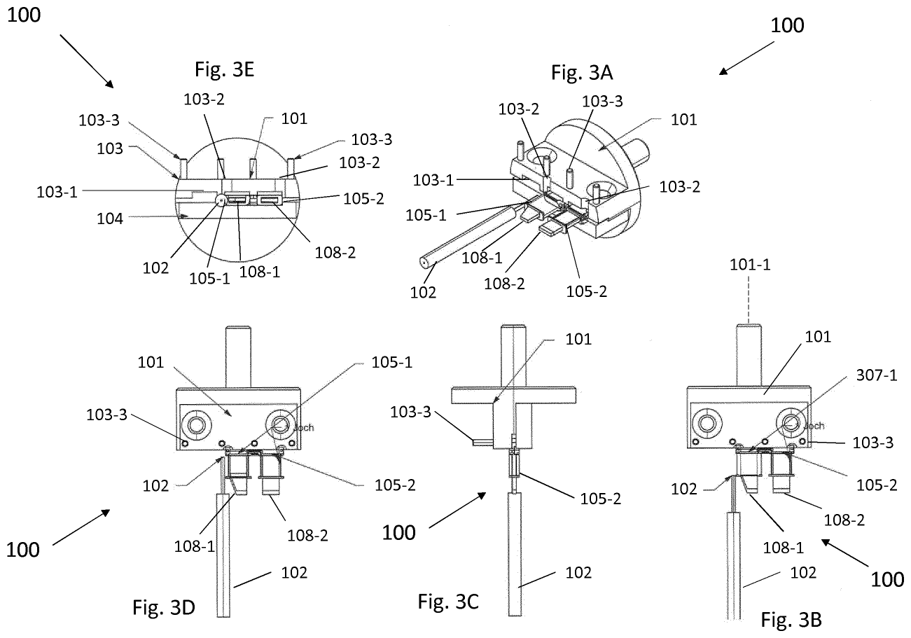

FIG. 3A shows a schematic perspective view of the winding device 100 according to an example described herein, wherein the coil yoke is positioned in the first positioning in the coil receptacle, and wherein the winding nozzle is positioned in the parallel position.

Compared to FIG. 2A, in FIG. 3A the winding nozzle 102 is pivoted into the parallel position and is thus oriented parallel to the axis of rotation 101-1 of the coil receptacle 101. As shown in FIG. 3A, the winding nozzle 102 is arranged next to the first coil former 105-1 and the first yoke limb 108-1.

In the parallel position of the winding nozzle 102, the winding device 100 is ready for winding around at the first coil former 105-1. For this purpose, the coil receptacle 101 rotates around the axis of rotation 101-1 and the first longitudinal axis 105-11 of the first coil former 105-1. In some examples, the winding nozzle 102 is configured to perform a translational movement along the axis of rotation 101-1 and along the first longitudinal axis 105-11 of the first coil former 105-1.

FIG. 3D shows a schematic top view of the winding device 100 in FIG. 3A, the winding nozzle 102 being moved along the axis of rotation 101-1 towards the coil receptacle 101. According to FIG. 3D, for winding the first winding 307-1 of the first coil former 105-1, the winding nozzle 102 starts in a position adjacent to the coil receptacle 101 and moves in alternating translatory back and forth movements along the axis of rotation 101-1 during the winding process and along the first longitudinal axis 105-11 of the first coil former 105-1 away from the coil receptacle 101 and towards the coil receptacle 101. This allows a spiral winding with several layers of coil wire to be achieved.

FIG. 3B shows a schematic top view of the winding device 100 in FIG. 3A, the winding nozzle being moved away from the coil receptacle along the axis of rotation. In comparison to FIG. 3D, the winding process of the first winding 307-1 is completed in FIG. 3B and the winding nozzle 102 has reached one end of the first coil former 105-1.

FIG. 3C shows a schematic side view of the winding device 100 in FIG. 3A.

FIG. 3E shows a schematic enlarged front view of the winding device 100 in FIG. 3A.

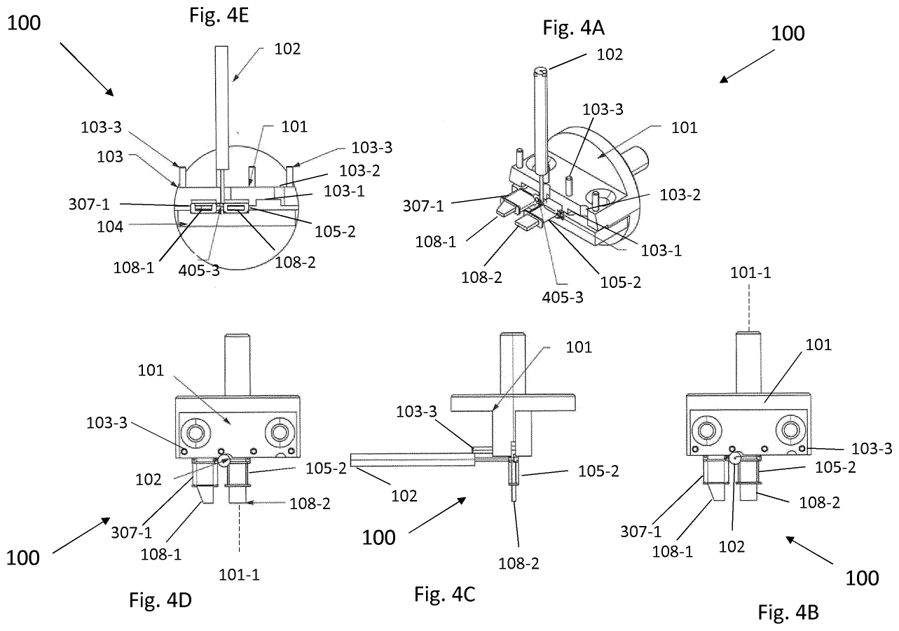

FIG. 4A shows a schematic perspective view of the winding device 100 according to an example described herein, the first winding 307-1 being formed at the first coil former 105-1, the coil yoke 108 being positioned in the second position in the coil receptacle 101, and wherein the winding nozzle 102 is positioned in the vertical position.

Compared to FIG. 3A, in FIG. 4A the winding process of the first winding 307-1 of the first coil former 105-1 is completed. The winding nozzle 102 is pivoted into the vertical position and the coil yoke 108 is positioned in the coil receptacle 101 in the second position, so that the second coil former 105-2 is arranged on the axis of rotation 101-1 and the second longitudinal axis 105-22 of the second coil former 105-2 coincides with the axis of rotation 101-1. As shown in FIG. 4A, the winding nozzle 102 is arranged between the first coil former 105-1 and the second coil former 105-2. Furthermore, through a passage 103-2 in the coil receptacle 101, the winding nozzle 102 is able to wind coil wire around a connecting pin 109 of the coil yoke 108.

In some examples, the first and second coil formers 105-1, 105-2 each have a coil former pocket 405-3.

FIG. 4B shows a schematic top view of the winding device 100 in FIG. 4A.

FIG. 4C shows a schematic side view of the winding device 100 in FIG. 4A.

FIG. 4D shows a further schematic top view of the winding device 100 in FIG. 4A.

FIG. 4E shows a schematic enlarged front view of the winding device 100 in FIG. 4A.

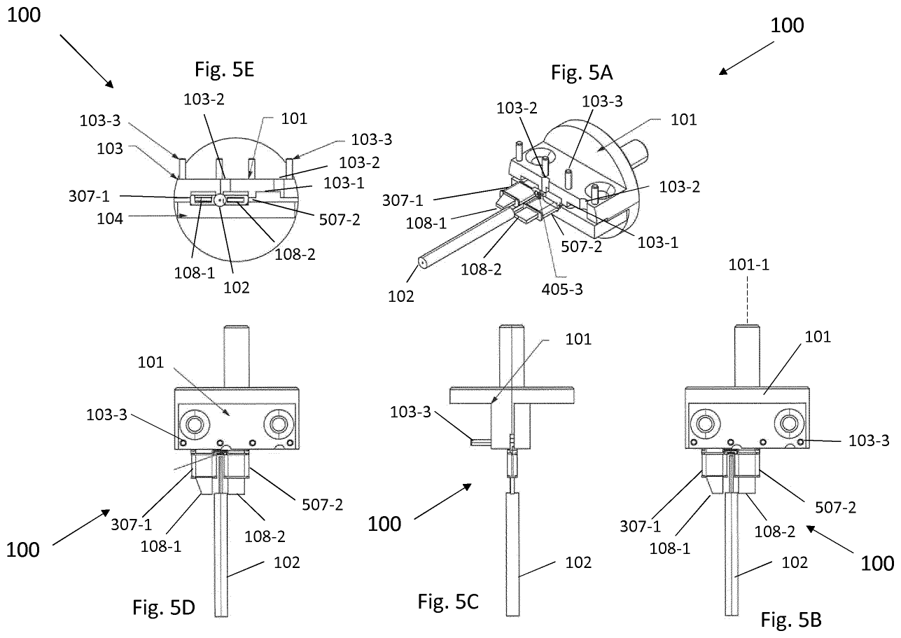

FIG. 5A shows a schematic perspective view of the winding device 100 according to an example described herein, the first winding 307-1 being formed at the first coil former 105-1 and the second winding 507-2 being formed at the second coil former 105-2, wherein the coil yoke 108 is positioned in the second position in the coil receptacle 101, and wherein the winding nozzle 102 is positioned in the parallel position.

Compared to FIG. 4A, in FIG. 5A the winding nozzle 102 is pivoted into the parallel position parallel to the axis of rotation 101-1 of the coil receptacle 101.

As illustrated in FIG. 5A, the winding nozzle 102 is arranged between the first coil former 105-1 and the second coil former 105-2 for the winding process of the second winding 507-2 of the second coil former 105-2. As a result of the rotation of the coil receptacle 101 around the axis of rotation 101-1 and around the second longitudinal axis 105-22, which coincides with the axis of rotation 101-1 in the second positioning of the coil yoke 108, coil wire can be wound around the second coil former 105-2 by the winding nozzle 102 and the generation of the second winding 507-2 of the second coil core 105-2 is made possible.

FIG. 5B shows a schematic top view of the winding device 100 in FIG. 5A.

FIG. 5C shows a schematic side view of the winding device 100 in FIG. 5A.

FIG. 5D shows a further schematic top view of the winding device 100 in FIG. 5A.

FIG. 5E shows a schematic enlarged front view of the winding device 100 in FIG. 5A.

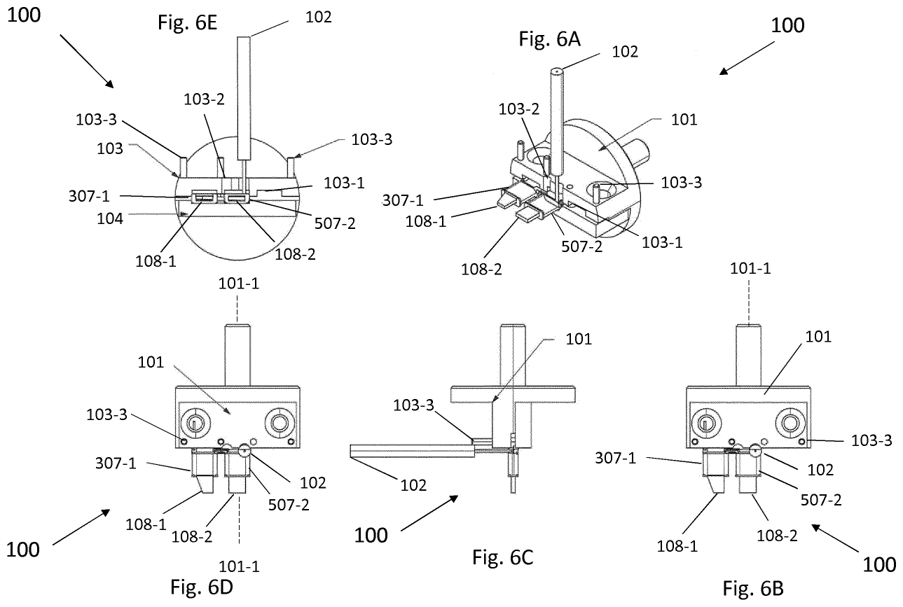

FIG. 6A shows a schematic perspective view of the winding device 100 according to an example described herein, the first winding 307-1 being formed at the first coil former 105-1 and the second winding 507-2 being formed at the second coil former 105-1, wherein the coil yoke 108 is positioned in the second position in the coil receptacle 101, and wherein the winding nozzle 102 is positioned in the vertical position.

Compared to FIG. 5A, in FIG. 6A the winding nozzle 102 is pivoted into the vertical position. After the completion of the second winding 507-2 of the second coil former 105-2, the winding nozzle 102 performs a rotational movement around a connecting pin 109 of the coil yoke 108 in order to wind the coil wire around it. Finally, the winding nozzle 102 winds a further support pin 103-3 of the coil receptacle 101 with coil wire and separates the coil wire between the connection pins 109 and the support pins 103-3, so that the coil yoke 108 with completed first and second windings 307-1, 507-2 of the first and second coil formers 105-1, 105-2 are released from the coil wire of the winding nozzle 102 and from the coil receptacle 101.

FIG. 6B shows a schematic top view of the winding device 100 in FIG. 6A.

FIG. 6C shows a schematic side view of the winding device 100 in FIG. 6A.

FIG. 6D shows a further schematic top view of the winding device 100 in FIG. 6A.

FIG. 6E shows a schematic enlarged front view of the winding device 100 in FIG. 6A.

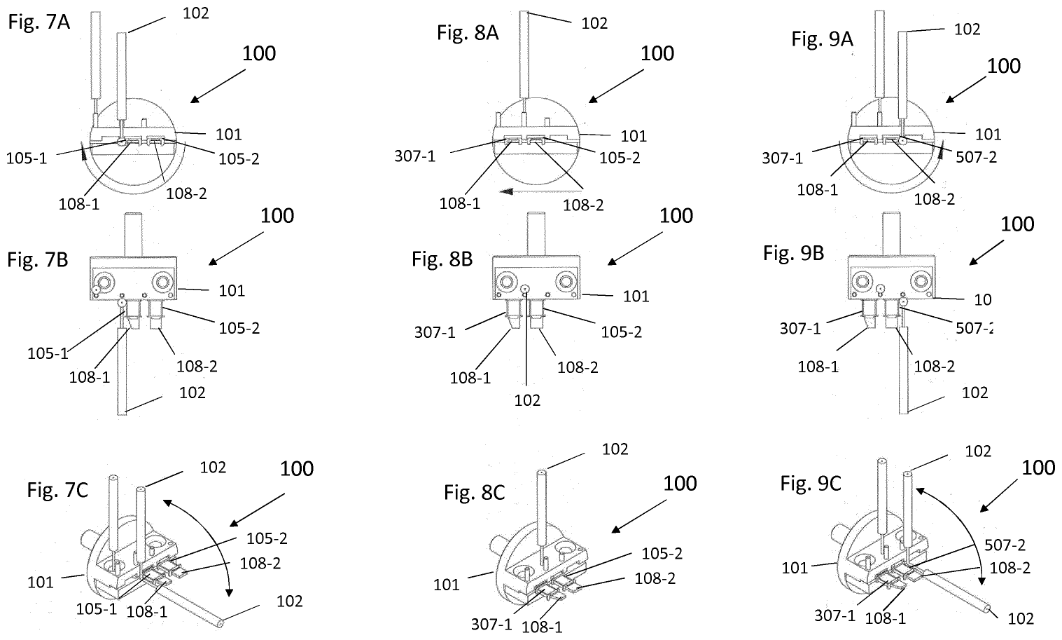

FIG. 7A shows a schematic enlarged front view of the winding device 100 according to an example described herein, wherein the coil yoke 108 is positioned in the first position at the coil receptacle 101, and wherein the winding nozzle 102 is shown positioned both in the vertical and in the parallel position.

To start the winding process, the coil yoke 108 is arranged in the first position at the coil receptacle 101 and the first coil former 105-1 is positioned on the axis of rotation 101-1 so that the first longitudinal axis 105-11 coincides with the axis of rotation 101-1. The winding nozzle 102 then winds coil wire in a vertical position around a support pin 103-3 of the coil receptacle 101, in order to fix the coil wire at the coil receptacle 101. The winding nozzle 102 then winds coil wire around a connecting pin 109 of the coil yoke 108 in order to fix the coil wire at the coil yoke 108.

To wind the first winding 307-1, the winding nozzle 102 is pivoted into the parallel position and arranged next to the first coil former 105-1. In the parallel position of the winding nozzle 102, the coil receptacle 101 rotates around the axis of rotation 101-1 and around the first longitudinal axis 105-11 of the first coil former 105-1 in a first direction of rotation, in order to produce the first winding 307-1 of the first coil former 105-1 with a first winding direction. For this purpose, in some examples, the coil receptacle 101 is configured to rotate in a first direction of rotation.

FIG. 7B shows a schematic top view of the winding device 100 in FIG. 7A.

FIG. 7C shows a schematic perspective view of the winding device 100 in FIG. 7A.

FIG. 8A shows a schematic enlarged front view of the winding device 100 according to an example described herein, wherein the coil yoke 108 is positioned in the second position in the coil receptacle 101, and wherein the winding nozzle 102 is positioned in the vertical position.

After completion of the first winding 307-1, the winding nozzle 102 is pivoted into the vertical position and the coil yoke 108 is shifted to the second position at the coil receptacle 101, so that the second longitudinal axis 105-22 of the second coil former 105-2 coincides with the axis of rotation 101-1.

FIG. 8B shows a schematic top view of the winding device 100 in FIG. 8A.

FIG. 8C shows a schematic perspective view of the winding device 100 in FIG. 8A.

FIG. 9A shows a schematic enlarged front view of the winding device 100 according to an example described herein, wherein the coil yoke 108 is positioned in the second position at the coil receptacle 101, and wherein the winding nozzle 102 is shown positioned both in the vertical and in the parallel position.

To wind the second winding 507-2 of the second coil former 105-2, the winding nozzle 102 is pivoted into the parallel position and arranged between the first coil former 105-1 and the second coil former 105-2. In the parallel position of the winding nozzle 102, the coil receptacle 101 rotates around the axis of rotation 101-1 and around the second longitudinal axis 105-22 of the second coil former 105-2 in a second direction of rotation, in order to produce the second winding 507-2 of the second coil former 105-2 with a second winding direction. For this purpose, the coil receptacle 101 is configured in some examples to rotate in a second direction of rotation which is opposite to the first direction of rotation. In this way it is possible to wind the first winding 307-1 with the first winding direction and the second winding 507-2 with the second winding direction opposite to the first winding direction.

After completion of the second winding 507-2, the winding nozzle 102 is pivoted into the vertical position. Then the winding nozzle 102 winds coil wire around a further connection pin 109 of the coil yoke 108 and around a further support pin 103-3 of the coil receptacle 101 and separates the coil wire between the wound connection pins of the coil yoke 108 and the corresponding wound support pins 103-3 of the coil receptacle 101, in order to release the coil yoke 108 with the first and second windings 307-1, 507-2 from the coil wire of the winding nozzle 102 and from the coil receptacle 101.

FIG. 9B shows a schematic top view of the winding device 100 in FIG. 9A.

FIG. 9C shows a schematic perspective view of the winding device 100 in FIG. 9A.

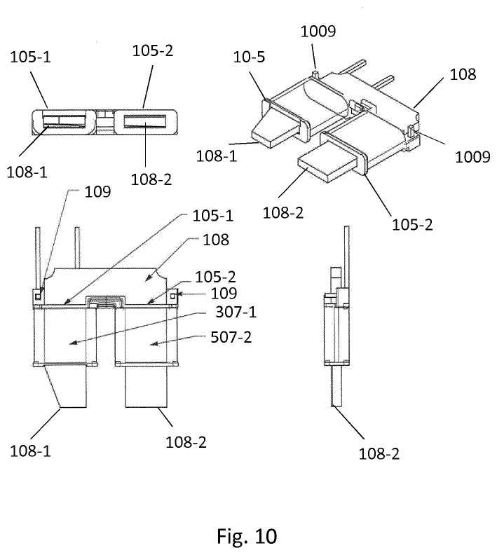

FIG. 10 shows schematic views of different perspectives of a U-shaped coil yoke 108 with two yoke limbs 108-1, 108-2 and two coil formers 105-1, 105-2 of a relay according to an example described herein of the present disclosure.

In some examples, the U-shaped coil yoke 108 comprises a first yoke limb 108-1 and a second yoke limb 108-2 arranged parallel to one another. The first coil former 105-1 is arranged on the first yoke limb 108-1 and the second coil former 105-2 is correspondingly arranged on the second yoke limb 108-2. A connector pin 109 is arranged below the first and second coil formers 105-1, 105-2 on each side of the coil yoke 108.

### LIST OF REFERENCE NUMBERS

100 winding device
101 winding receptacle
101-1 axis of rotation
102 winding nozzle
102-2 second axis of rotation
103 upper receiving part
103-1 passage
103-2 passage
103-3 support pin
104 lower receiving part
105-1 first coil former
105-11 first longitudinal axis
105-2 second coil former
105-22 second longitudinal axis
108 coil yoke
108-1 first yoke limb
108-2 second yoke limb
109 connector pin
307-1 first winding
405-3 coil former receptacle
507-2 second winding

What is claimed is:

1. A winding device for winding coil wire onto a first coil former and a second coil former of a coil yoke of a relay, the coil yoke having a first yoke limb comprising the first coil former and a second yoke limb comprising the second coil former, wherein the first coil former extends along a first longitudinal axis, the second coil former extends along a second longitudinal axis, and the first coil former and the second coil former are arranged next to each other and oriented parallel to one another, the winding device comprising:
a coil receptacle for holding the coil yoke, wherein the coil receptacle is rotatable around an axis of rotation that is oriented parallel to the first longitudinal axis and the second longitudinal axis, and wherein the coil receptacle is configured to support the coil yoke displaceably transversely to the axis of rotation to position the first coil former for winding coil wire onto the first coil former such that the first longitudinal axis coincides with the axis of rotation or to position the second coil former for winding coil wire onto the second coil former such that the second longitudinal axis coincides with the axis of rotation; and
a winding nozzle configured to dispense the coil wire parallel to the axis of rotation.

2. The winding device of claim 1, wherein the coil receptacle is configured to wind the coil wire of the winding nozzle onto the one of the first coil former or the second coil former whose longitudinal axis coincides with the axis of rotation by rotating the coil receptacle around the axis of rotation.

3. The winding device of claim 1, wherein the coil receptacle is configured to rotate in a first direction of rotation around the axis of rotation to produce a first winding of the first coil former with a first winding direction, and to rotate in a second direction of rotation around the axis of rotation to produce a second winding of the second coil former with a second winding direction, that is opposite to the first winding direction.

4. The winding device of claim 1, wherein the winding nozzle can be moved parallel to the axis of rotation and back and forth along the one of the first coil former or the second coil former whose longitudinal axis coincides with the axis of rotation to achieve a uniform winding of the one of the first coil former or the second coil former with coil wire.

5. The winding device of claim 1, wherein the coil receptacle comprises an upper receiving part and a lower receiving part configured to hold the coil yoke between the upper receiving part and the lower receiving part.

6. The winding device of claim 5, wherein the upper receiving part, the lower receiving part, or both, has passages which are arranged next to one another and can be penetrated by the first yoke limb and the second yoke limb, the first coil former and the second coil former being arranged outside the passages.

7. The winding device of claim 6, wherein the passages arranged next to one another define a first positioning of the coil yoke and a second positioning of the coil yoke in the coil receptacle, wherein, in the first positioning, the first longitudinal axis of the first coil former coincides with the axis of rotation, and wherein, in the second positioning, the second longitudinal axis of the second coil former coincides with the axis of rotation.

8. The winding device of claim 1, wherein the coil receptacle has a plurality of passages which penetrate the coil receptacle perpendicular to the axis of rotation and expose electrical connections of the coil yoke for an electrical connection of coil wire.

9. The winding device of claim 1, wherein the coil receptacle has a plurality of support pins configured to fix the coil wire to the coil receptacle during a winding process.

10. The winding device of claim 1, wherein the winding nozzle can be pivoted vertically from a position parallel to the axis of rotation to enable connection pins of the coil yoke, support pins of the coil receptacle, or both, to be wound.

11. The winding device of claim 10, wherein the winding nozzle can be pivoted transversely to the axis of rotation in a vertical position to reach, for winding with coil wire, different connection pins of the coil yoke, different support pins of the coil receptacle, or both.

12. The winding device of claim 10, wherein the winding nozzle can be rotated in a vertical position around a second axis of rotation that is oriented at an right angle to the axis of rotation of the coil receptacle to achieve winding, with coil wire, of the connection pins of the coil yoke, the support pins of the coil receptacle, or both.

13. The winding device of claim 10, wherein the winding nozzle is configured to separate coil wire between a wound connection pin and a wound support pin to end a winding process.

14. The winding device of claim 1, wherein the first coil former and the second coil former are shaped sleeve-like from a dielectric material.

15. A method for winding coil wire on a first coil former and a second coil former of a coil yoke of a relay, comprising:
arranging the coil yoke in a coil receptacle that is rotatable around an axis of rotation that is oriented parallel to a first longitudinal axis along which the first coil former extends and to a second longitudinal axis along which the second coil former extends;
displacing the coil yoke in the coil receptacle transversely to the axis of rotation;
positioning one of the first coil former or the second coil former so that its longitudinal axis coincides with the axis of rotations;
dispensing through a winding nozzle, coil wire parallel to the longitudinal axis of the one of the first coil former or the second coil former whose longitudinal axis coincides with the axis of rotation; and
rotating the coil receptacle around the axis of rotation to wind the coil wire of the winding nozzle on the one of the first coil former or the second coil former whose longitudinal axis coincides with the axis of rotation.

16. The method of claim 15, wherein rotating the coil receptacle around the axis of rotation comprises:
rotating the coil receptacle in a first direction of rotation around the axis of rotation, wherein the first coil former comprises a first winding with a first winding direction based at least in part on rotating the coil receptacle in the first direction of rotation; and
rotating the coil receptacle in a second direction of rotation around the axis of rotation, wherein the second coil former comprises a second winding with a second winding direction based at least in part on rotating the coil receptacle in the second direction of rotation.

17. The method of claim 15, further comprising;
moving the winding nozzle parallel to the axis of rotation and back and forth along the one of the first coil former or the second coil former whose longitudinal axis coincides with the axis of rotation, wherein the one of the first coil former or the second coil former comprises a uniform winding with coil wire based at least in part on the moving.

18. The method of claim 15, further comprising:
holding the coil yoke between an upper receiving part of the coil receptacle and a lower receiving part of the coil receptacle based at least in part on arranging the coil yoke in the coil receptacle.

19. The method of claim 15, further comprising:
pivoting the winding nozzle vertically from a position parallel to the axis of rotation to a vertical position; and
winding connection pins of the coil yoke based at least in part on vertically pivoting the winding nozzle.

20. The method of claim 19, further comprising:
pivoting the winding nozzle transversely to the axis of rotation in the vertical position; and
winding different connection pins of the coil yoke based at least in part on transversely pivoting the winding nozzle.
